(19) United States
(12) Patent Application Publication
(10) Pub. No.: US 2024/0407384 A1
(43) Pub. Date: Dec. 12, 2024

(54) Oil Crystallization Promoter, Preparation Method Therefor and Use Thereof

(71) Applicant: Jiangnan University, Wuxi (CN)

(72) Inventors: Yuanfa LIU, Wuxi (CN); Xiuhang CHAI, Wuxi (CN)

(21) Appl. No.: 18/811,929

(22) Filed: Aug. 22, 2024

Related U.S. Application Data
(63) Continuation of application No. PCT/CN2022/137549, filed on Dec. 8, 2022.

(30) Foreign Application Priority Data
May 31, 2022 (CN) 2022106065199

(51) Int. Cl. A23D 9/007; A23D 9/04; C11B 7/00

(52) U.S. Cl. CPC A23D 9/007; A23D 9/04; C11B 7/0016

(57) ABSTRACT

Disclosed are an oil crystallization promoter, a preparation method therefor and a use thereof, belonging to the technical field of dietary oil processing and control. Components of the oil crystallization promoter of the present disclosure include, by mass percentage: 50%-70% Dipalmito-olein (PO), 10%-20% Dipalmitin (PP), and 15%-30% Diolein (OO), adding up to 100%. The oil crystallization promoter of the present disclosure can increase the crystallization rate of oil, promote rapid formation and stabilization of a stable β′ crystal form of the oil, accelerate rapid crystallization and stabilization of confectionery- and baking-specific fat products such as margarine, shortening and cocoa butter substitute, and inhibit product graininess and post-hardening.

### TECHNICAL FIELD

The present disclosure relates to an oil crystallization promoter, a preparation method therefor and a use thereof, belonging to the technical field of dietary oil processing and control.

### BACKGROUND

A fat crystal network formed by oil crystallization determines the taste, texture, and flavor of dietary oils such as margarine and shortening. A good crystal network helps to shape the structure of a processed food, encapsulate air, and provide a soft and moist taste, while a poor crystal network can cause problems such as poor plasticity and graininess of a product, losing expected functional characteristics and operational performance, and seriously affecting a quality of the product.

Palm oil is widely used in margarin and shortening due to high production, low price, and diverse product types thereof. The crystallization characteristics of palm oil, especially a strong B′ crystallization tendency of palm oil, can endow a product with a delicate crystal structure, and directly affect the texture, taste, and stability of the product. However, due to a low crystallization rate of palm oil, freshly produced margarin has a soft texture. During storage, the palm oil will continue to crystallize and grow into larger crystal particles, forming a strong network structure, resulting in graininess or post-hardening of a product, and seriously affecting the quality and use characteristics of the product.

To address product defects caused by the low crystallization rate of palm oil, the most commonly used method is to add high melting point triglycerides and emulsifiers to promote fat crystallization. For example, patent document JP 2007-124948A proposes that dehydrated sorbitol saturated fatty acid esters with an esterification rate of 20%-50% can inhibit the formation of granular crystals in palm oil. Similarly, patent JP 3434463B proposes a water-in-oil type emulsified fat composition prepared from sorbitol saturated fatty acid esters and palm oil, which does not produce coarse crystals. However, these methods focus on the inhibition of crystal coarseness during storage of palm oil-based products, but do not involve the issue of product texture (such as graininess or post-hardening). Moreover, these methods do not involve whether they affect the crystallization rate of fat. Patent JP 101990571A finds that dehydrated sorbitol fatty acid esters with an esterification rate of 28%-60% and a sorbitol type content of 20%-40% can significantly promote fat crystallization, but does not mention the effect thereof on crystal change and texture change during storage of palm oil-based products. In addition, the emulsifiers used in the above patents are obtained by chemical synthesis, which consumes a lot of energy, has low yield and high cost, and does not meet the healthy consumption needs of people's pursuit of clean labels.

Therefore, there is an urgent need for a natural emulsifier that can promote oil crystallization, inhibit crystal growth during storage, and inhibit product graininess and post-hardening when applied to margarine and shortening.

### SUMMARY

### Technical Problem

Palm oil has a low crystallization rate, which leads to further crystallization of palm oil-based products such as margarine and shortening during storage, forming coarse crystals and causing quality deterioration such as graininess or post-hardening of the products.

### Technical Solution

To solve the aforementioned problem, the present disclosure provides an oil crystallization promoter that can induce fat crystallization, accelerate the formation of oil crystals, improve a crystal size, optimize a structure and texture of a crystal network, and inhibit product graininess and post-hardening.

A first objective of the present disclosure is to provide an oil crystallization promoter, components of the oil crystallization promoter include, by mass percentage: 50%-70% Dipalmito-olein (PO), 10%-20% Dipalmitin (PP), and 15%-30% Diolein (OO), adding up to 100%.

A second objective of the present disclosure is to provide a method for preparing the oil crystallization promoter of the present disclosure, including the following steps:
dissolving an oil sample in petroleum ether, loading the sample into a silica gel chromatography column, performing first elution with a mixed solvent of the petroleum ether and ether to obtain purified triglycerides, then performing second elution with a mixed solvent of the petroleum ether and the ether, and removing the solvent to obtain the oil crystallization promoter.

In one embodiment of the present disclosure, the oil sample includes one or both of palm oil and palm stearin.

The palm oil involved in the present disclosure includes palm oil with a melting point of 24° C. and medium melting point palm oil with a melting point in a range of 28° C.-33° C.

In one embodiment of the present disclosure, a ratio of an amount used of the oil sample to the petroleum ether is 30 g:120 mL.

In one embodiment of the present disclosure, the silica gel chromatography column is prepared by adding 60 g of column chromatography silica gel to a chromatography glass column (diameter 2.5 cm, length 40 cm) with a polytetrafluoroethylene stopper.

In one embodiment of the present disclosure, in the first elution, a volume ratio of the petroleum ether to the ether in the mixed solvent is 95:5; and in the second elution, the volume ratio of the petroleum ether to the ether in the mixed solvent is 80:20.

A third objective of the present disclosure is to provide an oil-fat mixture containing the oil crystallization promoter of the present disclosure.

In one embodiment of the present disclosure, components of the oil-fat mixture include, by mass percentage: 0.5%-5% oil crystallization promoter, and balance of oil, adding up to 100%.

In one embodiment of the present disclosure, an oil includes one or both of palm oil and palm stearin, and the palm oil includes palm oil with a melting point of 24° C. and medium melting point palm oil with a melting point in a range of 28° C.-33° C.

A fourth objective of the present disclosure is to provide a use of the oil crystallization promoter of the present disclosure in the field of food.

In one embodiment of the present disclosure, the food includes margarin, shortening, frozen food specific oil, cocoa butter substitute, or food fillings.

### Beneficial Effects

The oil crystallization promoter of the present disclosure can increase the crystallization rate of an oil, promote rapid formation and stabilization of a stable β′ crystal form of the oil, accelerate rapid crystallization and stabilization of confectionery- and baking-specific fat products such as margarine, shortening and cocoa butter substitute, and inhibit product graininess and post-hardening.

### BRIEF DESCRIPTION OF FIGURES

FIG. 1A shows polarized micrographs of oil-fat mixture obtained from Comparative Example 1.

FIG. 1B shows polarized micrographs of oil-fat mixture obtained from Example 1.

FIG. 1C shows polarized micrographs of oil-fat mixture obtained from Example 2.

FIG. 1D shows polarized micrographs of oil-fat mixture obtained from Example 3.

FIG. 1E shows polarized micrographs of oil-fat mixture obtained from Comparative Example 2.

FIG. 1F shows polarized micrographs of oil-fat mixture obtained from Comparative Example 3.

FIG. 1G shows polarized micrographs of oil-fat mixture obtained from Comparative Example 4.

FIG. 2 shows a trend of the hardness of the oil-fat mixture of Example 4 changes with storage time.

FIG. 3 shows a comprehensive sensory evaluation analysis result of Example 7.

### DETAILED DESCRIPTION

The preferred examples of the present disclosure will be described below. It should be understood that the examples are for better explaining the present disclosure and are not intended to limit the present disclosure.

### Testing Methods:

### 1. Molecular Composition Analysis of Oil Crystallization Promoter:

Referring to AOCS Ce5-86, Agilent 7820A high-temperature gas chromatography is used for determination. GC chromatographic conditions: RTX-65TG high-temperature capillary column (30 m×0.25 mm×0.1 μm), injection port temperature: 350° C., and FID detector temperature: 360° C.

### 2. Determination of Induction Time:

Palm oil is placed in a clean and dry beaker and heated in an 80° C. water bath for 30 min to remove crystal memory. Then, a crystallization promoter is added and the oil sample is stirred in a temperature-controlled magnetic stirrer at a rate of 300 rpm at 80° C. for 30 min to ensure uniform mixing.

Approximately 2.5 g of the oil sample is weighed and placed in an NMR glass tube. The sample is taken out every 30 s to measure the solid fat content (SFC) thereof at 5° C. until the SFC remains constant. A graph of the SFC changing with the crystallization time is obtained, and the induction time for palm oil nucleation is obtained through linear fitting.

### 3. Determination of Crystal Size:

A droplet (about 10 μL) of a melted sample is taken using a preheated capillary tube and placed on a preheated glass slide. Then, a preheated cover glass is placed on the surface of the oil droplet to form a thin and uniform film without generating bubbles. Then, the sample is placed in a 20° C. constant temperature incubator to crystallize for 24 h. The sample is photographed and observed using a Leica DM2700P polarizing microscope (PLM). The obtained polarizing microscope images are quantitatively analyzed using Image J 1.42 image processing software to obtain the average crystal size.

### 4. Determination of Crystal Form:

The crystal form of an oil at different storage time points is measured using a powder X-ray diffractometer with a copper lamp (λ=1.54 Å), a light source intensity of 30 kV, a divergence slit of 1.0 mm, a scattering slit of 1.0 mm, and a receiving slit of 0.3 mm. The sample is scanned from 11° to 30° at a rate of 1°/min.

### 5. Determination of Texture:

The hardness of a palm oil sample at different storage time points is measured using a texture analyzer, with a P/45C probe, where pre-test speed: 1.00 mm/s; test speed: 2.00 mm/s; post-test speed: 2.00 mm/s; trigger force: 5.0 g; and puncture depth: 12.00 mm. The maximum pressure value is used as the hardness indicator. Each sample is measured 6 times to take the average.

### Example 1

A method for preparing an oil crystallization promoter is provided, including the following steps:

30 g of palm oil (with a melting point of 24° C.) was dissolved in 120 ml of petroleum ether, loaded into a silica gel chromatography column, eluted with a mixed solvent of petroleum ether and ether (in a volume ratio of 95:5) to obtain purified palm oil triglycerides (PO-TAG), and then, further eluted with a mixed solvent of petroleum ether and ether (80/20, v/v) to obtain a natural oil crystallization promoter.

The obtained oil crystallization promoter was subjected to molecular composition analysis. The results are shown in Table 1:

TABLE 1
Molecular composition of oil crystallization promoter

| Composition | PO | PP | OO |
|---|---|---|---|
| Content | 61.2 | 15.3 | 23.5 |

The obtained oil crystallization promoter was added to palm oil at 0%, 0.5%, 1%, 1.5%, 2%, 2.5%, 3%, 4%, 5%, and 6% (w/w), respectively, and the induction time was determined. The test results are shown in Table 2:

TABLE 2
Effect of crystallization promoter on induction time for oil crystallization

| | Amount of crystallization promoter added (wt %) | | | | | | | | | |
|---|---|---|---|---|---|---|---|---|---|---|
| | 0 | 0.5 | 1 | 1.5 | 2 | 2.5 | 3 | 4 | 5 | 6 |
| Nucleation induction | 4.16 | 3.64 | 3.48 | 3.17 | 2.85 | 2.32 | 2.04 | 1.93 | 1.90 | 1.89 |
| time (min) | | | | | | | | | | |

From Table 2, the addition of the oil crystallization promoter can significantly shorten the nucleation induction time. The shorter the nucleation induction time, the higher the oil nucleation rate, which promotes the nucleation and crystallization of an oil. The optimal amount added is 0.5%-5%.

### Example 2

Consistent with Example 1, except that the palm oil in Example 1 was replaced with a medium melting point palm oil (with a melting point of 33° C.), to obtain an oil crystallization promoter.

### Example 3

Consistent with Example 1, except that the palm oil in Example 1 was replaced with palm stearin, to obtain an oil crystallization promoter.

The obtained oil crystallization promoter was subjected to molecular composition analysis. The results are shown in Table 3:

TABLE 3
Molecular composition of oil crystallization promoter

| Composition | PO | PP | OO |
|---|---|---|---|
| Example 2 | 59.4 | 19.3 | 21.3 |
| Example 3 | 64.6 | 25.8 | 9.6 |

### Example 4

A method for preparing an oil-fat mixture is provided, including the following steps:

Palm oil (with a melting point of 24° C.) was placed in different clean and dry beakers, heated and melted in an 80° C. water bath, and maintained for 30 min to remove crystal memory. 1.5% oil crystallization promoter of Example 1 was added, heated and stirred in an 80° C. water bath, and mixed uniformly using a vortex oscillator to obtain the oil-fat mixture.

### Example 5

A method for preparing an oil-fat mixture is provided, including the following steps:

Palm oil (with a melting point of 24° C.) was placed in different clean and dry beakers, heated and melted in an 80° C. water bath, and maintained for 30 min to remove crystal memory. 1.5% oil crystallization promoter of Example 2 was added, heated and stirred in an 80° C. water bath, and mixed uniformly using a vortex oscillator to obtain the oil-fat mixture.

### Example 6

A method for preparing an oil-fat mixture is provided, including the following steps:

Palm oil (with a melting point of 24° C.) was placed in different clean and dry beakers, heated and melted in an 80° C. water bath, and maintained for 30 min to remove crystal memory. 1.5% oil crystallization promoter of Example 3 was added, heated and stirred in an 80° C. water bath, and mixed uniformly using a vortex oscillator to obtain the oil-fat mixture.

### Comparative Example 1

Consistent with Example 4, except that the addition of the oil crystallization promoter in Example 4 was omitted, to obtain an oil-fat mixture.

### Comparative Example 2

Consistent with Example 4, except that the oil crystallization promoter in Example 4 was replaced with sorbitol palmitate, to obtain an oil-fat mixture.

### Comparative Example 3

Consistent with Example 4, except that the oil crystallization promoter in Example 4 was replaced with sorbitol stearate, to obtain an oil-fat mixture.

### Comparative Example 4

Consistent with Example 4, except that the oil crystallization promoter in Example 4 was replaced with sucrose ester S-170 (Mitsubishi Chemical Food Co., Ltd.), to obtain an oil-fat mixture.

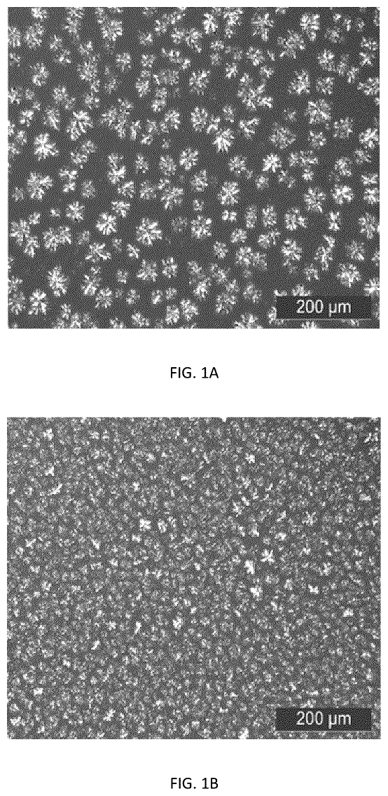

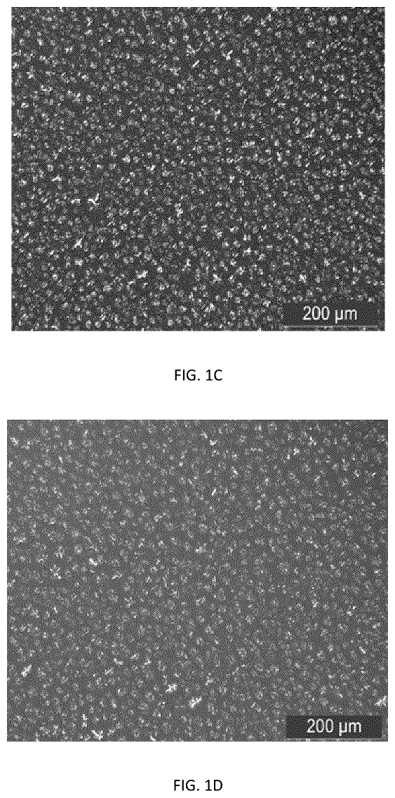

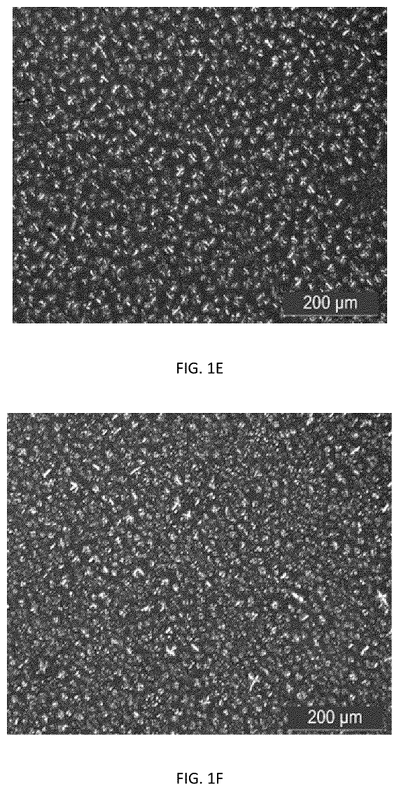

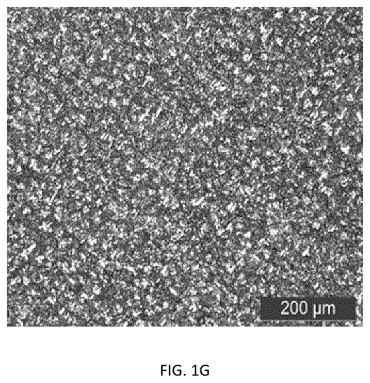

The obtained oil-fat mixture was subjected to crystal size testing. The test results are shown in FIG. 1A-G and Table 4.

From FIG. 1A-G and Table 4, with the addition of the oil crystallization promoter, the crystal particle size of the palm oil decreases, the number of crystals increases, and the microstructure becomes denser. Examples 1 to 3 have a more significant effect on promoting oil crystallization compared to commercially available emulsifiers (Comparative Examples 2 to 4), and obtain more compact crystal network structures.

TABLE 4
Effect of crystallization promoter on the crystal particle size of palm oil

| | Comparative | Example | Example | Example | Comparative | Comparative | Comparative |
|---|---|---|---|---|---|---|---|
| Groups | Example 1 | 4 | 5 | 6 | Example 2 | Example 3 | Example 4 |
| Average | 23.67 | 9.09 | 7.76 | 5.95 | 10.56 | 9.71 | 12.88 |
| crystal | | | | | | | |
| size | | | | | | | |
| (μm) | | | | | | | |

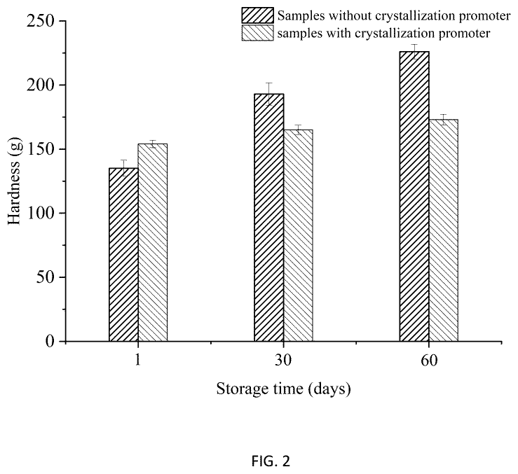

The oil-fat mixture of Example 4 was crystallized and matured at 25° C. for 24 h, then stored in a constant temperature incubator at 25° C. for a long time, and sampled on day 30 and day 60 to determine the crystal form and texture thereof. Meanwhile, palm oil without any substances added was used as a control experiment. The results are shown in Table 5 and FIG. 2.

From Table 5, the oil-fat mixture of Example 4 exhibits a stable B′ crystal form, which inhibits the formation of a B crystal form and contributes to the crystallization stability of a fat sample.

From FIG. 2, the control sample without the oil crystallization promoter added shows a gradual increase in hardness during storage and severe post-hardening, which is also attributed to the appearance of the B crystal form in the palm oil during storage. After the oil crystallization promoter of Example 4 is added, the hardness remains basically the same during storage, and the addition of the oil crystallization promoter inhibits the post-hardening of the palm oil.

TABLE 5
Effect of crystallization promoter on oil crystal form

| Storage time (days) | | 1 | 30 | 60 |
|---|---|---|---|---|
| Crystal | Control experiment | β′ | β′ + β | β′ + β |
| form | group (palm oil) | | | |
| | Group added with | β′ | β′ | β′ + β |
| | crystallization | | | |
| | promoter | | | |
| | (Example 4) | | | |

### Comparative Example 5

Consistent with Example 4, except that the oil crystallization promoter in Example 4 was replaced with PO, to obtain an oil-fat mixture.

### Comparative Example 6

Consistent with Example 4, except that the oil crystallization promoter in Example 4 was replaced with PP, to obtain an oil-fat mixture.

### Comparative Example 7

Consistent with Example 4, except that the oil crystallization promoter in Example 4 was replaced with OO, to obtain an oil-fat mixture.

The crystallization time and crystal particle size of the oil-fat mixtures obtained from Example 4 and Comparative Examples 5, 6, and 7 were tested. The test results are as follows:

TABLE 6
Effects of crystallization promoter on crystal
nucleation time and crystal size of palm oil

| | | Comparative | Comparative | Comparative |
|---|---|---|---|---|
| Groups | Example 4 | Example 5 | Example 6 | Example 7 |
| Nucleation induction | 3.17 | 3.82 | 3.31 | 4.15 |
| time (min) | | | | |
| Average crystal | 9.09 | 10.94 | 9.82 | 22.95 |
| size (μm) | | | | |

From Table 6, the crystal nucleation time of Example 4 is shorter than those of Comparative Examples 5 to 7, and the average crystal size of Example 4 is smaller than those of Comparative Examples 5 to 7. The oil crystallization promoter promotes the crystallization of the palm oil, and results in a decrease in the crystal particle size thereof. Compared with single use of the PO, the PP, and the OO, the crystallization promoter 1 has a better effect and shows a synergistic action.

### Comparative Example 8

Consistent with Example 1, except that the eluents petroleum ether and ether (80/20, v/v) in Example 1 were replaced with n-hexane and ether (80/20, v/v), to obtain an oil crystallization promoter. Afterwards, an oil-fat mixture was prepared according to Example 4.

The nucleation induction time and the crystal size of the obtained oil-fat mixtures were measured.

The results show that the nucleation induction time of the oil-fat mixture is 3.56 min, which is longer than the crystallization induction time (3.17 min) of Example 4; and the crystal size of the oil-fat mixture is 11.23 μm, which is larger than the crystal size (9.09 μm) of Example 4. It can be seen that the ability of the oil crystallization promoter of the present Comparative Example to promote oil nucleation and crystallization is weaker than that of the oil crystallization promoter prepared in Example 1. Therefore, the degree of purity of the oil crystallization promoter is different when different eluents are used, and the ability to promote oil crystallization is reduced.

### Example 7

A use of the oil crystallization promoter in shortening is provided, including the following steps:

The formula of shortening containing the oil crystallization promoter (by mass) includes: 98.2% base oil (palm oil), 0.3% lecithin, and 1.5% oil crystallization promoter.

The formula of shortening not containing the oil crystallization promoter (by mass) includes: 99.7% base oil (palm oil) and 0.3% lecithin.

Palm oil-based shortening was prepared by stirring for 2 min, refrigerating for 30 s, stirring for 2 min, refrigerating for 30 s, stirring for 2 min, refrigerating for 30 s, stirring for 2 min, refrigerating for 30 s, stirring for 2 min, refrigerating for 30 s, stirring for 2 min, refrigerating for 30 s, and stirring for 5 min in an ice cream machine.

Graininess was induced under a storage condition with temperature fluctuations (5° C. for 12 h and 20° C. for 12 h in a cycle of temperature fluctuation). At the beginning of storage and after storage, the palm oil-based shortening was subjected to crystal form determination and sensory analysis of granularity continuously for a period of 7 days.

6 people were selected to form a sensory evaluation team. 5 training sessions were arranged before a formal test. Quantitative descriptive analysis was conducted. The evaluation was conducted in a standard sensory evaluation room. Specifically, an appropriate amount of sample was taken with a small spoon, gently rubbed between the thumb and the index finger to sense granular crystals, and scored. The scoring criteria are shown in Table 7. 0.5 was taken between two scoring criteria, and the average value and standard deviation of the final scoring data were plotted.

TABLE 7
Sensory evaluation criteria

| Granularity | Score |
|---|---|
| High granularity | 5 |
| Relatively high granularity | 4 |
| Acceptable granularity | 3 |
| Almost no granules can be felt | 2 |
| Almost no granules | 1 |

TABLE 8
Changes in crystal form

| Storage time (weeks) | | 0 | 2 | 4 | 6 | 8 |
|---|---|---|---|---|---|---|
| Crystal | Not added with oil | β′ | β′ | β′ + β | β′ + β | β |
| form | crystallization promoter | | | | | |
| | Added with oil | β′ | β′ | β′ | β′ | β′ + β |
| | crystallization promoter | | | | | |

From Table 8, all the newly prepared oil-fat mixtures are in the B′ crystal form, which has a delicate crystal structure. With the increased storage time, the crystal form changed. After 4 weeks of storage under temperature fluctuations, a sample not added with the oil crystallization promoter had partially transformed into β form crystals, and by the 8th week, all crystals were transformed into the β form. However, a sample added with the oil crystallization promoter maintained B′ form crystals for the first 6 weeks, until partial β form crystals appeared after 8 weeks of storage. The B form crystals can cause a granular sensation in the sample, indicating that the oil crystallization promoter has an effect of inhibiting the graininess of the palm oil-based shortening.

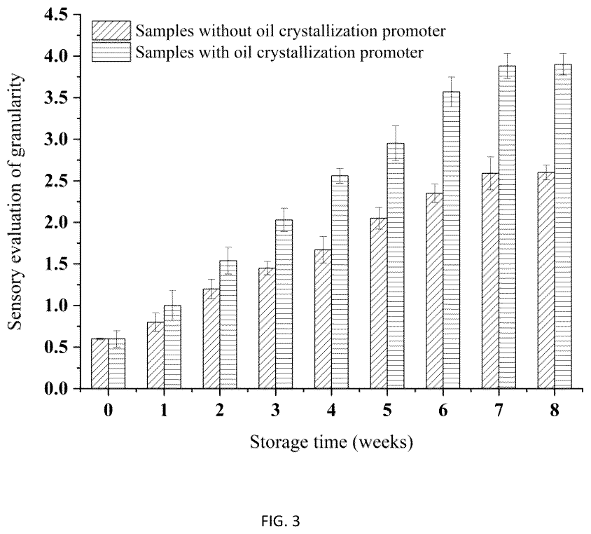

The comprehensive sensory evaluation analysis results are shown in FIG. 3. From FIG. 3, the palm oil-based shortening gradually experiences graininess with a longer storage time. The sample not added with the oil crystallization promoter shows a relatively high granularity in weeks 7 and 8, while the sample added with the oil crystallization promoter still reached an acceptable granularity even after 8 weeks of storage. Therefore, the oil crystallization promoter inhibits the graininess of the palm oil-based shortening and improves the quality of the product.

Although the present disclosure has been disclosed as above in preferred examples, the present disclosure is not limited thereby. Anyone familiar with the art can make various changes and modifications without departing from the spirit and scope of the present disclosure. Therefore, the protection scope of the present disclosure should be defined by the claims.

What is claimed is:

1. An oil crystallization promoter, wherein components of the oil crystallization promoter comprise, by mass percentage: 50%-70% Dipalmito-olein (PO), 10%-20% Dipalmitin (PP), and 15%-30% Diolein (OO), adding up to 100%.

2. A method for preparing the oil crystallization promoter according to claim 1, comprising the following steps:
dissolving an oil sample in petroleum ether, loading the oil sample into a silica gel chromatography column, performing first elution with a first mixed solvent of the petroleum ether and ether to obtain purified triglycerides, then further performing second elution with a second mixed solvent of the petroleum ether and the ether, and removing the second mixed solvent to obtain the oil crystallization promoter.

3. The method according to claim 2, wherein the oil sample comprises one or both of palm oil and palm stearin.

4. The method according to claim 2, wherein a ratio of an amount used of the oil sample to the petroleum ether is 30 g:120 mL.

5. The method according to claim 2, wherein in the first elution, a volume ratio of the petroleum ether to the ether in the first mixed solvent is 95:5; and in the second elution, the volume ratio of the petroleum ether to the ether in the second mixed solvent is 80:20.

6. An oil-fat mixture, containing the oil crystallization promoter according to claim 1.

7. The oil-fat mixture according to claim 6, wherein components of the oil-fat mixture comprise, by mass percentage: 0.5%-5% oil crystallization promoter and balance of oil, adding up to 100%.

8. The oil-fat mixture according to claim 7, wherein an oil or fat comprises one or both of palm oil and palm stearin.
